(19) United States
(12) Patent Application Publication
(10) Pub. No.: US 2025/0201496 A1
(43) Pub. Date: Jun. 19, 2025

(54) SWITCH ASSEMBLY EQUIPPED WITH A SLIDING COVER FOR ONBOARD PRESSURE-ACTIVATED SWITCHES

(71) Applicant: Division Group, LLC, Broussard, LA (US)

(72) Inventor: Trent Zimmer, Youngsville, LA (US)

(73) Assignee: Division Group, LLC, Broussard, LA (US)

(21) Appl. No.: 18/988,814

(22) Filed: Dec. 19, 2024

Related U.S. Application Data
(60) Provisional application No. 63/612,260, filed on Dec. 19, 2023.

(51) Int. Cl. H01H 9/02

(52) U.S. Cl. CPC H01H 9/0264; H01H 2223/044

(57) ABSTRACT

Switch assemblies, each equipped with a sliding cover for onboard pressure-activated switches, are disclosed.

### CROSS-REFERENCE TO RELATED APPLICATION(S)

This application claims the benefit of U.S. Provisional Application Ser. No. 63/612,260, filed on Dec. 19, 2023, the entirety of which is incorporated herein by reference.

### TECHNICAL FIELD

This disclosure relates switch assemblies, each equipped with a sliding cover for onboard pressure-activated switches.

### BACKGROUND

Firearm accessories such as lights, aiming lasers, and laser illuminators are routinely used by warfighters and police officers in tactical environments. These devices are actuated by switches, which are often positioned for operational efficiency. Unfortunately, the unintentional actuation of these switches can result in light emissions visible to an enemy, thereby compromising operational security.

Firearms are often equipped with environment-specific lighting and aiming solutions. The switches for these devices are frequently positioned in tandem or adjacent to each other. In low-light or no-light environments, such as when wearing a night vision device, it may be beneficial for the user to have tactile differentiation between visible and IR lighting and aiming solutions.

Accordingly, there is a need for the switch assemblies, each equipped with a sliding cover for onboard pressure-activate switches, disclosed herein. The present invention is directed to providing switch assemblies configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Switch assemblies, each equipped with a sliding cover for onboard pressure-activated switches, are disclosed.

An example switch assembly comprises: a first switch configured to actuate the firearm-mounted electronic device; a second switch configured to actuate the firearm-mounted electronic device; and a switch cover configured to cover at least a portion of one switch. The switch cover is slidably suspended and movable to individually cover either the first switch or the second switch.

Another example switch assembly comprises: a first switch configured to actuate the firearm-mounted electronic device; a second switch configured to actuate the firearm-mounted electronic device; and a switch cover configured to cover at least a portion of one switch, and comprising a contact surface and a plunger. The plunger having a rest position and a contact position, with the plunger depending from an underside of the switch cover. The switch cover is slidably suspended and movable to individually cover either the first switch or the second switch. Pressing the contact surface of the switch cover moves the plunger from the rest position to the contact position.

### BRIEF DESCRIPTION OF THE DRAWINGS

FIG. 1 is a perspective view of a remote switch assembly equipped with a switch cover, which is in accordance with the principles of the present disclosure.

FIG. 2 is an exploded view of the remote switch assembly shown in FIG. 1.

FIG. 3 is a side elevational view of the left rail clamp.

FIG. 4 is a side elevational view of the right rail clamp.

FIG. 5 is a perspective view of the switch cover.

FIG. 6 is a perspective view of a remote switch assembly equipped with another switch cover, which is in accordance with the principles of the present disclosure.

FIG. 7 is a perspective view of the switch cover shown in FIG. 6.

FIG. 8 is another perspective view of the switch cover shown in FIG. 6.

FIG. 9 is a cross-sectional view of the remote switch assembly, taken along line 10-10 shown in FIG. 6.

Like reference numerals refer to corresponding parts throughout the several views of the drawings.

### DETAILED DESCRIPTION

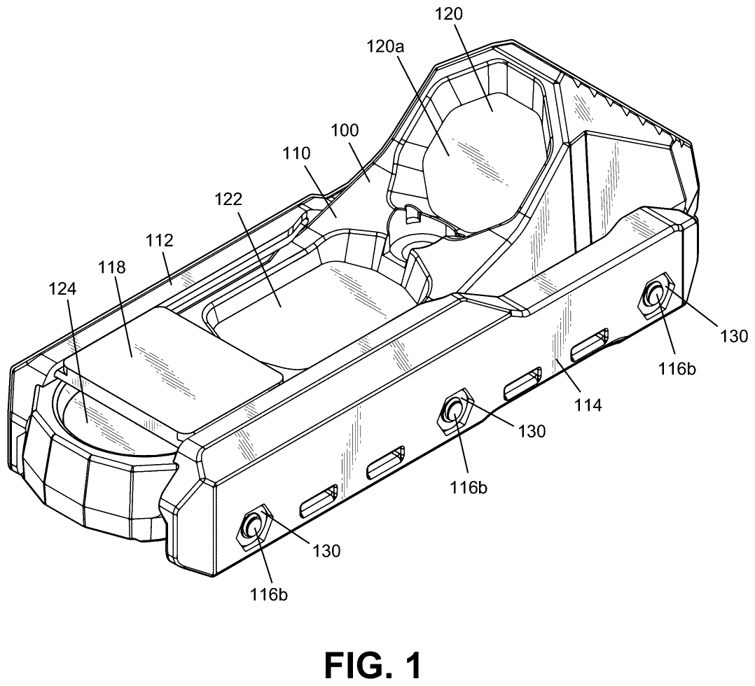

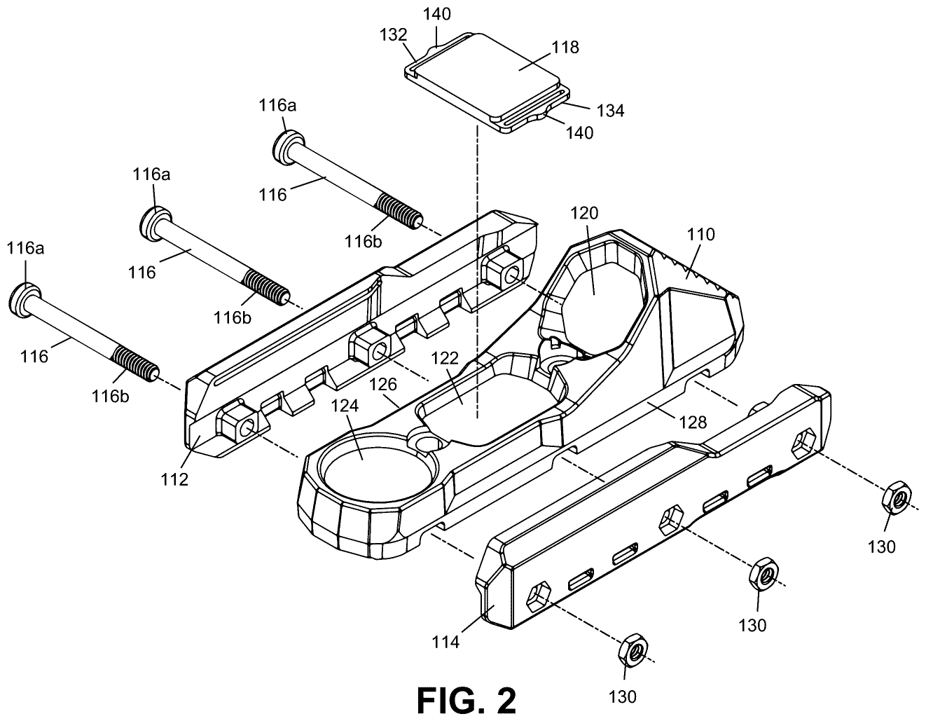

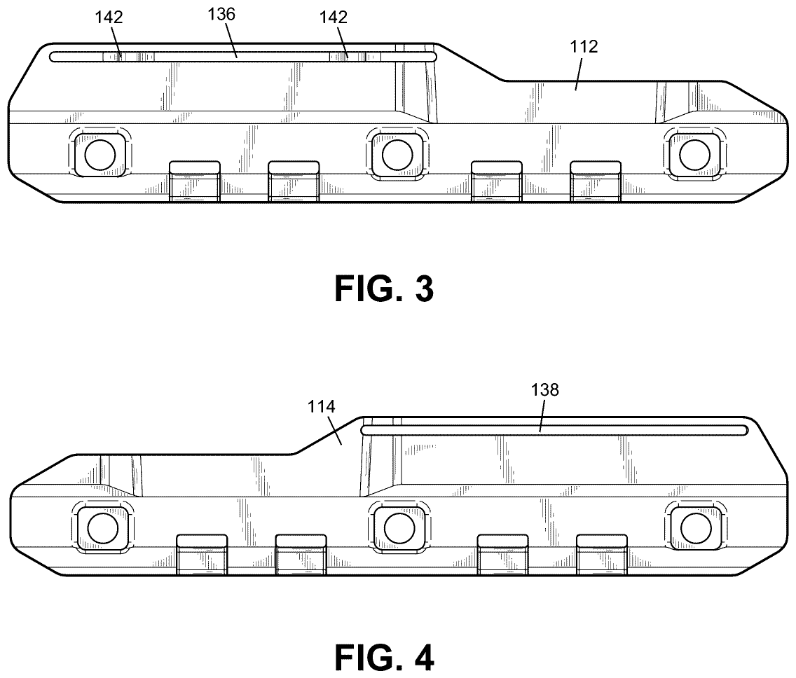

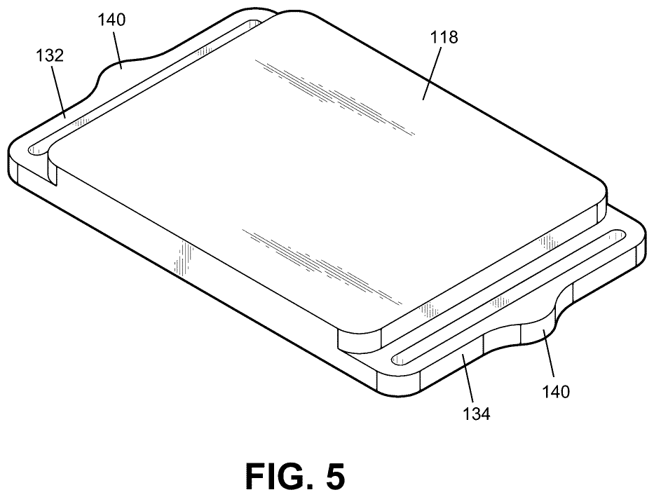

FIG. 1 illustrates a remote switch assembly 100 equipped with a switch cover 118, which is in accordance with the principles of the present disclosure. The remote switch assembly 100 is used to actuate (e.g., turn on/off) firearm-mounted electronic devices, such as flashlights and laser aiming modules. The switch cover 118 is used to selectively cover an underlying switch and prevent its actuation.

The remote switch assembly 100 comprises a control module 110, a first rail clamp 112, a second rail clamp 114, and a sliding switch cover 118.

The control module 110 includes three switches (120, 122, 124), each connected to a plug by a flexible cable (not shown). The first switch 120 has a 45-degree angled button face 120a and is a pressure-activated switch configured to provide both momentary and constant-on modes of operation. However, in some implementations, the first switch 120 may be configured to provide momentary-only activation. The second switch 122 and the third switch 124 are pressure-activated switches configured to provide momentary-only activation.

The two rail clamps (112, 114) are used in conjunction with three threaded fasteners 116 (e.g., threaded cross bolts) to fixedly clamp the remote switch assembly 100 to a rail interface system, such as a MIL-STD-1913 rail. The first rail clamp 112 and the second rail clamp 114 are configured to be positioned on a first lateral side 126 and a second lateral side 128, respectively, of the control module 110. Each threaded fastener 116 extends laterally through openings in the rail clamps (112, 114). The head 116a of each fastener 116 is positioned in a counterbore in one rail clamp 112, and the threaded end 116b extends through the opposite rail clamp 114 to removably couple with a threaded hex nut 130 positioned in a recess. The control module 110 is secured to a rail interface system by tightening each of the threaded fasteners 116, which compresses the rail clamps (112, 114) laterally and draws the rail clamps (112, 114) together, thereby securely clamping the control module 110 to the rail interface system.

Although not shown, in some implementations, the remote switch assembly 100 may be configured for attachment to another accessory mounting interface, such as one or more M-LOK® slots or other accessory mounting apertures.

The switch cover 118 is slidably suspended between the two rail clamps (112, 114). Each end (132, 134) of the switch cover 118 is positioned within a longitudinally extending groove (136, 138), with each groove (136, 138) being formed in a portion of a respective rail clamp (112, 114). Together, the grooves (136, 138) define a track configured to allow a user to slidably position the switch cover 118 over either the second switch 122 or the third switch 124. The switch cover 118 is further configured to prevent actuation of the underlying switch (122 or 124).

The switch cover 118 is a rigid, substantially planar member that includes an indexing tab 140 positioned on each end (132, 134). The groove (136, 138) of each rail clamp (112, 114) includes two indexing recesses 142. The indexing recesses 142 in each rail clamp (112, 114) are positioned to align with corresponding indexing recesses 142 in the opposing rail clamp, when the rail clamps (112, 114) are secured to the control module 110. Each indexing tab 140 of the switch cover 118 is configured to engage with a corresponding indexing recess 142. A pair of indexing recesses 142, consisting of two aligned indexing recesses 142 positioned opposite each other and adjacent to one of the switches (122, 124), receive the indexing tabs 140 and interact to releasably fix the switch cover 118 in position over one of the two underlying switches (122, 124). The indexing tabs 140 snap into the indexing recesses 142 when the switch cover 118 is slid into position, providing tactile feedback and securing the switch cover 118 in place. This configuration ensures proper alignment of the switch cover 118 over an underlying switch (122 or 124) and prevents unintended movement during operation.

While the switch cover 118 is shown installed on a remote switch assembly 100 that includes three switches (120, 122, 124), it should be understood that the switch cover 118 can also be used with a switch assembly that includes only two flat switches, such as the second and third switches (122, 124) shown in FIG. 1. Additionally, the switch cover 118 can be adapted for use in an onboard switch assembly of an electronic device, such as a laser aiming module.

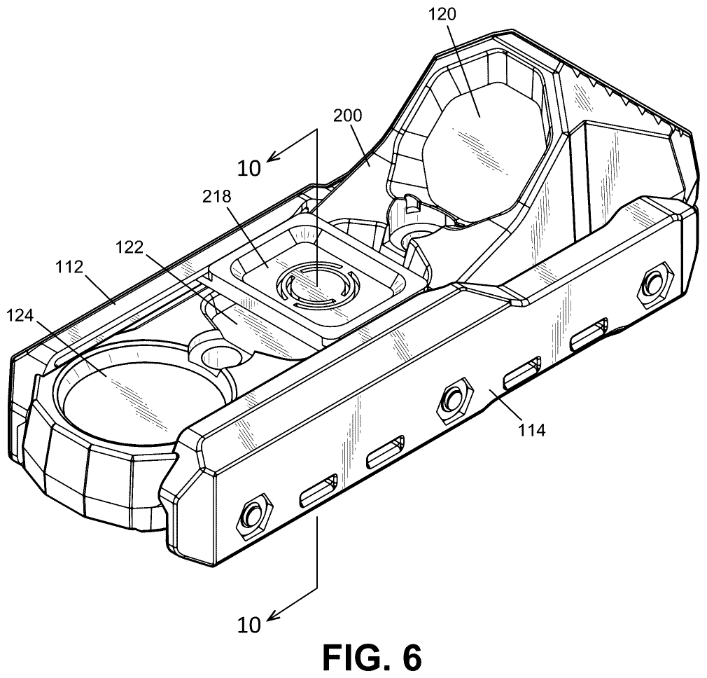

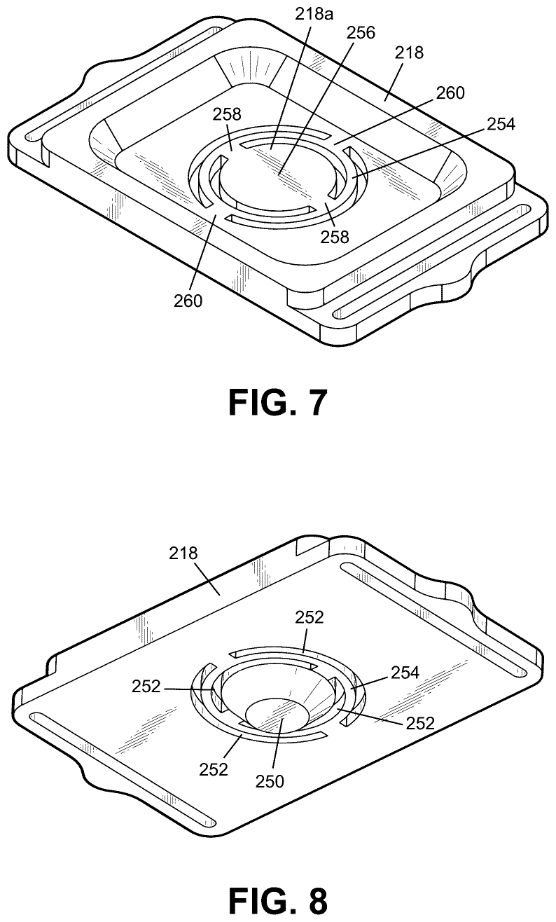

FIG. 6 illustrates the remote switch assembly 100 equipped with another switch cover 218, which is in accordance with the principles of the present disclosure. The switch cover 218 is similar to the switch cover 118 disclosed above but includes a plunger 250 on its underside. The switch cover 218 is configured such that the plunger 250 makes contact with an underlying switch (e.g., the second switch 122 or the third switch 124) when the switch cover 218 is pressed.

The plunger 250 is a truncated cone-shaped protrusion depending from the underside of the switch cover 218, configured to actuate the underlying switch (122 or 124) when a predetermined threshold force is applied to the contact surface 218a of the switch cover 218. Additionally, the switch cover 218 not only actuates the underlying switch (122 or 124) but also provides tactile differentiation between a covered switch (e.g., switch 122 as shown in FIG. 6) and an uncovered switch (e.g., switch 124 as shown in FIG. 6). While the example plunger 250 is a truncated cone, the plunger 250 may alternatively have any other shape suitable for actuating an underlying switch.

The switch cover 218 is configured to elastically deform when the predetermined threshold force is applied to its contact surface 218a. In some implementations, the switch cover 218 includes flexure cutouts 252 in the contact surface 218a that extend through the switch cover 218. These flexure cutouts 252 facilitate deformation of the switch cover 218, allowing the plunger 250 to be pressed into contact with the underlying switch. The flexure cutouts 252 form a ring 254 that encircles the base 256 of the plunger 250. The ring 254 is connected to the base 256 of the plunger 250 by a pair of flexure links 258 and to the remainder of the switch cover 218 by another pair of flexure links 260. Together, these features create a flexible framework that allows for controlled deformation of the switch cover 218 when force is applied. Each pair of flexure links (258, 260) consists of two flexure links positioned on opposite sides of the ring 254. The pair of flexure links 258 connecting the ring 254 to the base 256 of the plunger 250 extend radially inward from the interior side of the ring 254, and the pair of flexure links 260 connecting the ring 254 to the remainder of the switch cover 218 extend radially outward from the exterior side of the ring 254. The flexure cutouts 252 and associated structure are provided as a nonlimiting example, with the understanding that one or more cutouts of other shapes could be used to form a switch cover 218 configured to elastically deform under applied force.

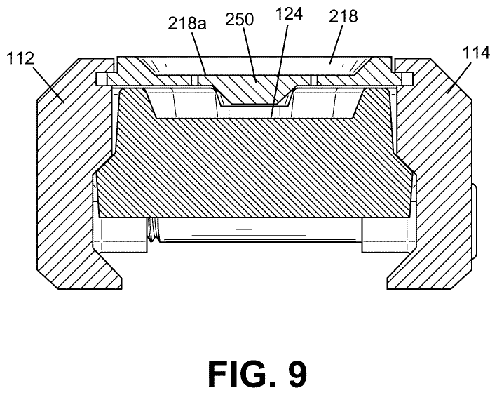

In summary, the switch cover 218 is configured such that pressing the contact surface 218a transitions the plunger 250 from a rest position (as shown in FIG. 9), in which the plunger 250 does not contact the underlying switch 124, to a contact position, which actuates the underlying switch 124.

Unless indicated otherwise, it will be understood that suitable wiring, traces, or a combination thereof, connect the electrical components of the control module 110 disclosed herein.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A switch assembly used to actuate a firearm-mounted electronic device, the switch assembly comprising:
a first switch configured to actuate the firearm-mounted electronic device;
a second switch configured to actuate the firearm-mounted electronic device; and
a switch cover configured to cover at least a portion of one switch;
wherein:
the switch cover is slidably suspended and movable to individually cover either the first switch or the second switch.

2. The switch assembly of claim 1, wherein the switch cover is a rigid and substantially planar member.

3. The switch assembly of claim 2, wherein the switch cover is slidably suspended between two longitudinally extending grooves.

4. The switch assembly of claim 3, wherein:
the switch cover includes an indexing tab positioned on each end;
the two longitudinally extending grooves are positioned opposite each other;
each of the two longitudinally extending grooves includes two indexing recesses; and
the indexing recesses in each longitudinally extending groove are configured to releasably engage the indexing tab on one end of the switch cover and are positioned to align with corresponding indexing recesses in the opposing longitudinally extending groove.

5. A switch assembly used to actuate a firearm-mounted electronic device, the switch assembly comprising:
a first switch configured to actuate the firearm-mounted electronic device;
a second switch configured to actuate the firearm-mounted electronic device; and
a switch cover configured to cover at least a portion of one switch, and comprising a contact surface and a plunger, the plunger having a rest position and a contact position, with the plunger depending from an underside of the switch cover;
wherein:
the switch cover is slidably suspended and movable to individually cover either the first switch or the second switch; and
pressing the contact surface of the switch cover moves the plunger from the rest position to the contact position.

6. The switch assembly of claim 5, wherein the switch cover includes at least one flexure cutout configured to allow the contact area to elastically deform when pressed.

7. The switch assembly of claim 6, wherein the switch cover is slidably suspended between two longitudinally extending grooves.

8. The switch assembly of claim 7, wherein:
the switch cover includes an indexing tab positioned on each end;
the two longitudinally extending grooves are positioned opposite each other;
each of the two longitudinally extending grooves includes two indexing recesses; and
the indexing recesses in each longitudinally extending groove are configured to releasably engage the indexing tab on one end of the switch cover and are positioned to align with corresponding indexing recesses in the opposing longitudinally extending groove.
